(19) United States
(12) Patent Application Publication
(10) Pub. No.: US 2015/0342312 A1
(43) Pub. Date: Dec. 3, 2015

(54) HIKING STICK WITH MULTI-TOOL HANDLE

(71) Applicant: Bahram Khoshnood, Cumming, GA (US)

(72) Inventor: Bahram Khoshnood, Cumming, GA (US)

(21) Appl. No.: 14/295,119

(22) Filed: Jun. 3, 2014

(51) Int. Cl. A45B 3/00; B26B 9/02

(52) U.S. Cl. CPC A45B 3/00; B26B 9/02

(57) ABSTRACT

A hiking stick for use in traversing terrain has an elongated shaft having a first end and a second end. A handle is coupled to the elongated shaft second end to allow the user to grasp the hiking stick. The handle comprises a multi-tool arcuate blade that consists of a first end that couples to the elongated shaft second end, a spear tip, a generally concave blade positioned intermediate the spear tip and the arcuate blade first end, and a generally convex blade positioned intermediate the spear tip and the arcuate blade first end. A portion of the generally convex blade proximate the spear tip and a cutting edge intermediate the generally concave blade portion and the spear tip together form a spear head. A sheath is configured to cover the arcuate blade and allow the user to grasp the handle.

### BACKGROUND

The present invention relates generally to walking or hiking sticks and in particular to a walking stick having a built in multi-tool cutting blade.

Walking sticks have been used by hikers and travelers for centuries. Moreover, wilderness hikers typically carry multiple tools for hiking in the wilderness, such as brush axes, standard axes, spears for hunting in addition to other tools. Carrying additional tools can be cumbersome and weighty. The present walking stick seeks to overcome the disadvantages presented.

### SUMMARY

In one embodiment, a walking stick comprises an elongated shaft having a first end, a second end, and a handle coupled to the elongated shaft second end. In various embodiments, the handle comprises an arcuate blade having (i) a spear tip; (ii) a socket configured to be attached to the elongated shaft second end; (iii) a generally concave blade positioned intermediate the spear tip and the socket; and (iv) a generally convex blade positioned intermediate the spear tip and the socket.

In various embodiments, the socket has a first end and a second end that defines a blind bore therein. In various embodiments, the arcuate blade is coupled to the socket first end by weldments. In other embodiments, the arcuate blade may be integrally formed with the socket first end. In some embodiments, the socket elongated blind bore is centered on a central axis that intersects the spear tip.

In various embodiments, the arcuate blade further comprises a first generally concave grind line that extends from the arcuate blade first end to the spear tip and is separated from a blade edge of the generally concave blade by a blade surface that extends from the generally concave blade edge to the first generally concave grind line. In various embodiments, a second generally convex grind line extends from the spear tip to approximately the blade first end and is separated from a generally convex blade edge by a generally convex blade face that extends from the generally convex blade edge to the second generally convex grind line.

In various embodiments, the walking stick comprises a removable sheath that is configured to receive the curved blade and function as a handle for a user to grasp when using the walking stick to traverse terrain.

In another embodiment, a blade for a walking stick comprises (i) a curved blade having a first end and a spear shaped second end; (ii) an elongated socket connected to the blade first end where the socket is configured to attach to an elongated walking stick; (iii) a generally concave blade portion, positioned intermediate the spear shaped second end and the blade first end, is configured to cut tree branches; and (iv) a generally convex blade portion, positioned intermediate the spear shaped second end and the blade second end, is configured to operate as an axe. In various embodiments, the point of the spear tip is substantially centered on a central axis of the elongated socket. In some embodiments, a first portion of a cutting edge of the spear tip is formed from a portion of the generally convex blade that is distal from the socket. In some embodiments, a second portion of a cutting edge of the spear tip is formed from two generally triangular blade faces that together form the second portion of the spear tip. In some of these embodiments, a distal end of the concave blade portion terminates at the two generally triangular blade faces.

### BRIEF DESCRIPTION OF THE DRAWINGS

Having described various embodiments in general terms, reference will now be made to the accompanying drawings, which are not necessarily drawn to scale, and wherein:

FIG. 1 is a front plan view of an embodiment of a walking stick.

FIG. 2 is a right side view of the arcuate blade and socket of the walking stick of FIG. 1.

FIG. 3 is a top plan view of the arcuate blade and socket of FIG. 2.

FIG. 4 is a bottom perspective view of the arcuate blade and socket of FIG. 2.

FIG. 5 is a front plan view of an embodiment of a walking stick having a removable implement.

FIG. 6 is a partial exploded view of the walking stick of FIG. 5.

FIGS. 7A-7D are various embodiments of implements for use with the walking stick of FIGS. 5-6.

### DETAILED DESCRIPTION OF VARIOUS EMBODIMENTS

Various embodiments will now be described more fully herein with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In certain circumstances, hiking and/or camping requires a user to traverse uneven and steep terrain. The user in some cases must carry equipment for use on the hike and/or camp out. Multiple pieces of equipment may be cumbersome. Thus, a walking stick that contains multiple cutting tools for use during a hike/camp out is presented. The walking stick has an elongated shaft that may, or may not be adjustable depending on the use. A multi-blade tool is mounted to the top of the elongated shaft and may be used as a handle when a sheath is covering the multi-bladed tool. In particular, the multi-bladed tool has a substantially arcuate blade that has a generally concave first blade portion, a second generally convex blade portion and a spear shaped blade portion intermediate the generally concave and generally convex blade portions.

The spear shaped blade portion is partially formed from a portion of the generally convex blade portion and from a substantially triangular blade portion that is adjacent the top edge of the generally concave blade portion. A first end of the blade portion is coupled to a second end of a socket that is used to connect the multi-blade tool to the elongated shaft. In various embodiments, the socket is integrally formed with the multi-blade tool. The first end of the socket contains a blind bore that is configured to receive a second end of the elongated shaft. In various embodiments, the elongated shaft may be coupled to the first end of the socket by a threaded engagement.

In use the walking stick may be used similar to any other walking stick to assist the user in traversing steep of uneven terrain. If the user finds them in a situation where a cutting tool is needed, the user may remove the sheath covering the multi-blade cutting tool and use one of the three blade portions depending on their needs. For example, to cut brush, the user may use the concave blade portion, which is configured to help maintain the brush in the cutting area. The convex blade portion may be used as a standard axe for cutting wood and small brush. Finally, the spear shaped blade portion may be used for spearing fish or small animals.

In other embodiments, the walking stick may comprise a elongated shaft that terminates in a coupling that is configured to releasably attach an implement to the elongated shaft. In particular embodiments, the coupling has a longitudinal slot formed in one end that is configured to receive a substantially flat portion of the implement. In some embodiments, the flat portion of the implement is retained in the slot using threaded bolts. In other embodiments, the flat portion of the implement may be retained in the slot using a quick release mechanism such as a spring loaded ball, a spring loaded pin, or any other suitable quick release mechanism. In various embodiments, the implements may be any one of a fishing spear, a throwing spear, a saw, an axe blade or a sling shot.

### First Embodiment of a Hiking Stick

### Hiking Stick Structure

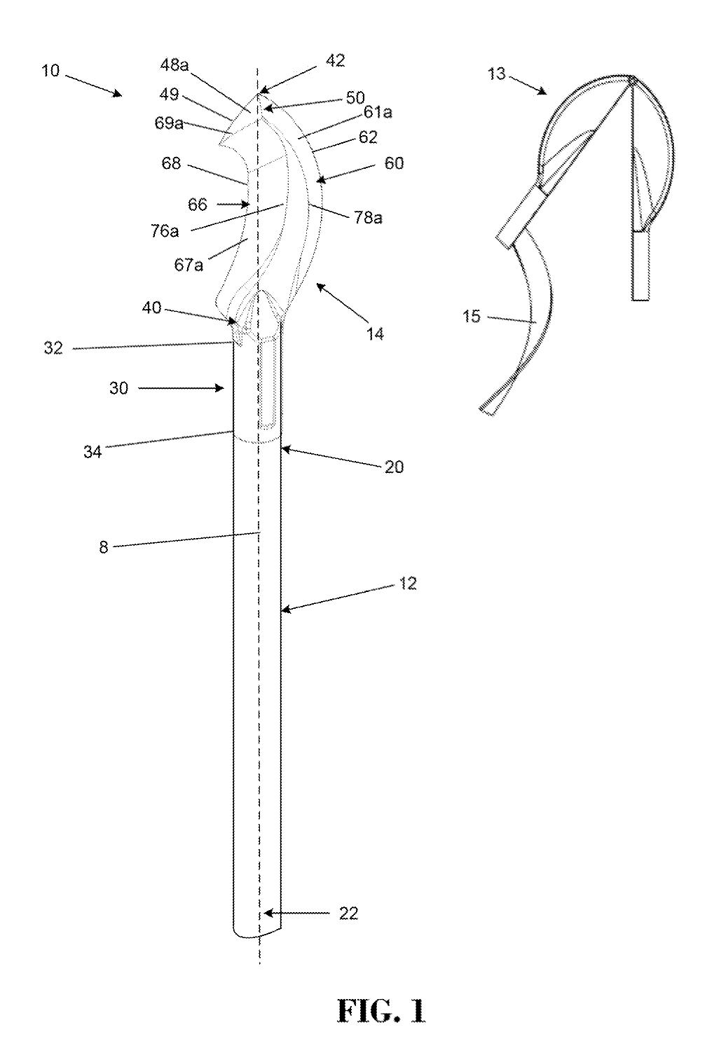

Referring to FIGS. 1-4, a walking stick 10 is shown having an elongated shaft 12 that is coupled to a multifunction arcuate blade 14 by a socket 30. The blade functions as a brush axe, a standard axe and a spear, as described in more detail below.

The elongated shaft 12 has a first end 20 and a second end 22. The shaft may be any suitable shape (e.g., cylindrical, rectangular, elliptical, square, etc.) and may be manufactured in different sizes to suit the user's requirements. The shaft may also be formed from any of various materials such as wood, polymer, plastic, rubber, metals, or composites, etc. In particular embodiments, the elongated shaft 12 is formed from wood and is cylindrical in shape.

Shafts made of wood may be customized by carving the user name, the name of the hiking group they belong to, or may have floral or other designs of the user's choice to make it look more fanciful and attractive. Moreover, the shaft may be of different weights to accommodate the needs of the user and can be modified for use in differing terrains that are uneven, slippery, wet or rocky. The shaft can also be manufactured in multiple colors to suit the users taste.

The elongated shaft 12 may also be telescopic to allow the length to be adjusted. For example, in various embodiments, the shaft may be formed from two parts (not shown), where an outer portion of the shaft has a larger diameter than that of an inner portion of the shaft thereby allowing the outer portion to slide over the inner portion of the shaft. In these embodiments, the outer portion of the shaft may contain a threaded hole that is configured to receive a threaded adjustable knob. To adjust the overall length of the shaft 12, the adjustable knob may be loosened so that the outer portion of the shaft moves relative to the inner portion of the shaft. Thus, once the user adjusts the overall length of the shaft to a suitable length, or the adjustable knob may be tightened to once again prevent the outer shaft portion from moving relative to the inner shaft portion. In an alternative embodiment, the shaft may also be made of two or more sections that can be screwed together or unscrewed to customize the length of the shaft. In still an alternative embodiment, the shaft may also have a push button type locking pin (e.g., a spring loaded pin or a spring loaded ball) (not shown) positioned in an outer circumference of the inner portion of the elongated shaft and a plurality of matching holes formed through the outer section of the elongated shaft thereby allowing the user to selectively fix the length of the shaft by affixing the locking pin in one of the holes.

The socket 30 has a first end 32, and a second end 34 that is configured to fixedly retain the elongated shaft first end 20 to the socket 30. In particular embodiments, the socket second end 34 has a bore 33 (FIG. 4) formed therein that is configured to attached to the elongated shaft 12. In particular embodiments, the shaft second end 34 is press-fit into the socket second end bore 33. In other embodiments, the shaft second end 20 is inserted into the socket second end bore 33 and retained therein by a fastener (e.g., a rivet, a screw, a nut and bolt, a cotter pin, etc.). In still other embodiments, the socket second end bore 33 may be threaded on an inner diameter (not shown) and the shaft second end may be threaded on an outer diameter (not shown). In these embodiments, the shaft is coupled to the socket by a threaded engagement. In a particular embodiment, the socket 30 is generally cylindrical (e.g., cylindrical) in shape and the second end bore 33 is also cylindrical in shape. In other embodiments, the socket 30 may be of any suitable shape (e.g., cylindrical, rectangular, elliptical, or square) that corresponds with the shape of the elongated shaft 12. Moreover, the socket second end bore 33 may be of any suitable shape (e.g., a shape that corresponds to the elongated shaft) to facilitate a fixed or removable connection to the shaft.

The arcuate blade 14 has a first end 40 and a spear tip shaped second end 42. The arcuate blade first end 40 is coupled to the elongated shaft 12 by the socket 30. That is, the socket first end 32 is coupled to the arcuate blade first end 40. In a particular embodiment, the socket 30 is integrally formed with the arcuate blade 14. In various embodiments, the socket first end 32 may be coupled to the arcuate blade first end 40 by weldments or by other suitable fasteners (e.g., screws, bolts, rivets, etc.). To achieve hardness and toughness, the arcuate blade 14 may be formed from various materials (e.g., copper, bronze, iron, steel, stainless steel, sharpened hard plastics, obsidian, flint, bone, synthetic sapphire, zirconium dioxide, etc.). Moreover, the multifunctional arcuate blade 14 may be of different sizes to accommodate its particular use.

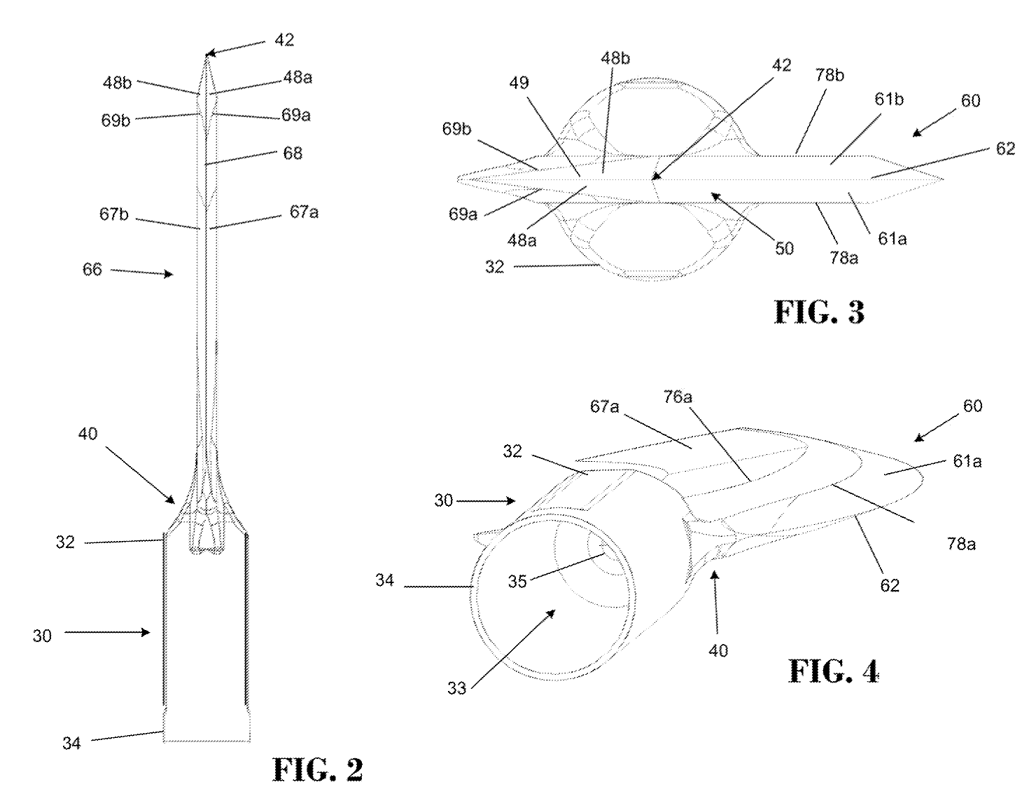

The arcuate blade 14 has a generally concave (e.g., concave) blade portion 66 positioned intermediate the spear tip second end 42 and the arcuate blade first end 40, and a generally convex (e.g., convex) blade portion 60 positioned intermediate the spear tip second end 42 and the arcuate blade first end 40. The concave blade portion 66 has a concave cutting edge 68 that extends from the arcuate blade first end 40 to a line 69a proximate the spear tip second end 42. A blade surface 67a begins at the arcuate blade first end 40, ends at the line 69a, and extends between the concave cutting edge 68 and a concave first grind line 76a. Referring to FIG. 2, a similar configuration is formed on the opposite side of the arcuate blade. That is, the concave cutting edge 68 extends from the arcuate blade first end 40 to a line 69b proximate the spear tip second end 42. Additionally, a blade surface 67b extends between the concave cutting edge 68 and a concave grind line (not shown) similar to that shown in FIG. 1. Thus, the concave cutting edge 68 is formed at the intersection of the blade surfaces 67a and 67b.

Referring once again to FIG. 1, the convex blade portion 60 has a convex blade edge 62 that extends from the blade first end 40 to the spear tip second end 42. The convex blade portion 60 has a convex cutting edge 62 that extends from the blade first end to the spear tip second end 42. A blade surface 61a begins at the blade first end 40, ends at the spear tip second end 42, and extends between the convex cutting edge 62 and a convex second grind line 78a. Referring to FIG. 3, a similar configuration is formed on the opposite side of the arcuate blade. That is, the convex cutting edge 62 extends from the arcuate blade first end 40 to the spear tip second end 42. Additionally, a blade surface 61b extends between the concave cutting edge 62 and a convex grind line 78b similar to that shown in FIG. 1. Thus, the convex cutting edge 62 is formed at the intersection of the blade surfaces 61a and 61b.

Referring to FIGS. 1 and 3, the convex blade edge 62 in combination with a blade edge 49 define a spear head portion 50, where the spear tip 42 is substantially centered on a central axis 8 (FIG. 1) of the elongated shaft 12 and socket 30. Said another way, the cutting surface of the spear head is formed from a portion of the convex cutting edge 62 that is proximate the spear tip second end 42 and the cutting edge 49. The cutting edge 49 of one half of the spear head portion 50 is formed at an intersection of a triangular blade portion 48a and a second triangular blade portion 48b that are bounded by the lines 69a and 69b.

In various embodiments, the walking stick 10 further comprises a removable sheath 13 (FIG. 1) that is configured to cover the arcuate blade 14 and function as a handle for a user to grasp when using the walking stick to traverse terrain. The sheath 13 is secured to the arcuate blade 14 by a strap 15 that is wrapped around the socket 30. The sheath 13 also protects the arcuate blade 14 from damage.

Exemplary Hiking Stick Operation

Walking sticks are used as an aid to walk and also to facilitate balancing while walking Walking sticks are generally used by the hikers, travelers and the aged. Generally, the walking stick is used as a balance point while crossing streams, to test the depth of the ice or muddied water, to clear a path while hiking or camping, to clear spider webs, and the like. In the design, when walking, the sheath 13 is placed over the blade and the sheath and blade together function as a handle to the walking stick. Thus, the user may grasp the covered arcuate blade without grasping the arcuate blade.

The multifunctional arcuate blade has been tailored in such a way that its various portions can be used for various cutting actions. The concave brush axe can be used for cutting small tree branches and brush. The concave shape helps to prevent the branch from slipping off the cutting edge. The outer convex blade portion may function like a standard axe blade and be used to cut or sharpen wood or to split large pieces of wood.

Finally, the spear tip 42 of the spear shaped portion 50 may be used as a weapon for self-defense against small animals or to spear small animals or fish for food. The spear tip may also be used to dig holes on the ground for securing spikes for a tent, or mark the route while traveling to leave a trail to follow.

Based on the user's requirements, the angle and the positioning of the arcuate blade, with respect to the elongated shaft, may be chosen for desired results. In addition, the height, weight, and the circumference of the walking stick may be customized as per the user's needs. Thus, the walking stick with the multi-functional arcuate blade of the present design provides a combination of multiple tools including a brush axe, a standard axe, a spear for hunting in addition to other cutting tools, which eliminates the need to separately carry similar tools and devices on one's body when walking, hiking, traversing, climbing, and the like.

### Second Embodiment of a Hiking Stick

### Hiking Stick Structure

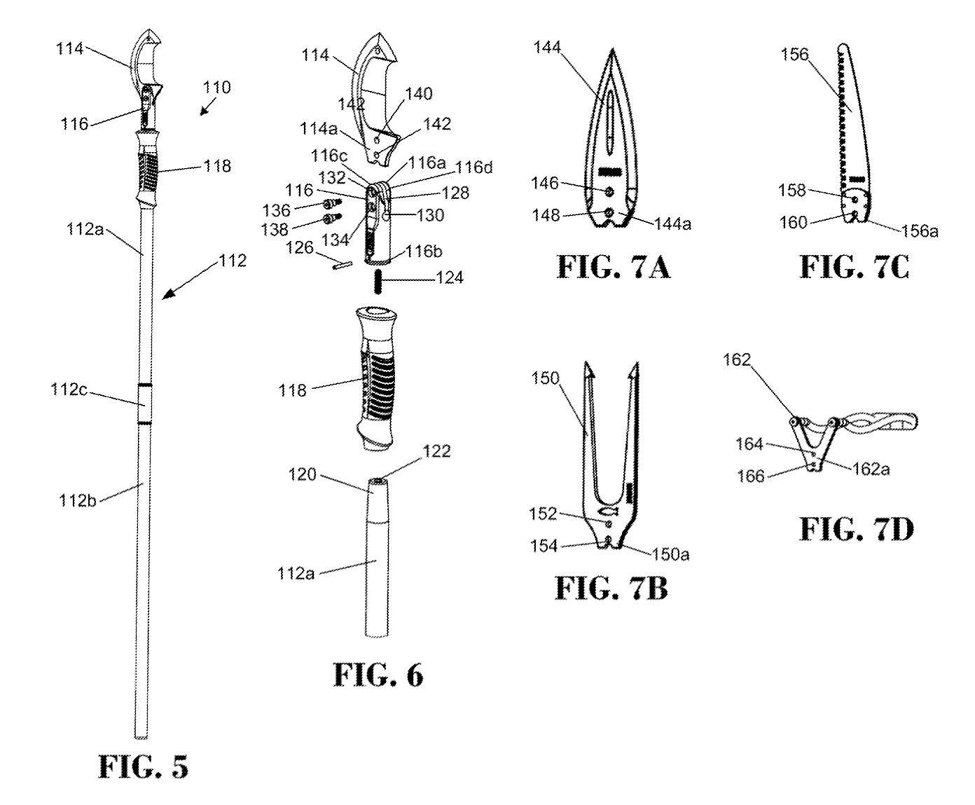

Referring to FIGS. 5-6, a walking stick 110 is shown having an elongated shaft 112 that is coupled to a multifunction arcuate blade 114 by a coupling 116. The arcuate blade 114 functions as a brush axe, a standard axe and a spear, as described above. The coupling 116 is configured to allow the user to easily remove the arcuate blade 114 and to replace it with another implement depending on the use of the walking stick 110, as described in greater detail below.

The elongated shaft 112 is split into two portions: a first portion 112a and a second portion 112b that are coupled together using a second coupling 112c. The shaft may be any suitable shape (e.g., cylindrical, rectangular, elliptical, square, etc.) and may be manufactured in different sizes to suit the user's requirements. In various embodiments, the shaft may be formed in multiple parts and coupled together (e.g., 3, 4 or 5 sections).

The shaft may also be formed from any of various materials such as wood, polymer, plastic, rubber, metals, or composites, etc. In particular embodiments, the elongated shaft 112 is formed from wood and is cylindrical in shape. Shafts made of wood may be customized by carving the user name, the name of the hiking group they belong to, or may have floral or other designs of the user's choice to make it look more fanciful and attractive. Moreover, the shaft may be of different weights to accommodate the needs of the user and can be modified for use in differing terrains that are uneven, slippery, wet or rocky. The shaft can also be manufactured in multiple colors to suit the users taste.

The elongated shaft 112 may also be telescopic to allow the length to be adjusted. For example, in various embodiments, the shaft may be formed from two parts (not shown), where an outer portion of the shaft has a larger diameter than that of an inner portion of the shaft thereby allowing the outer portion to slide over the inner portion of the shaft. In these embodiments, the outer portion of the shaft may contain a threaded hole that is configured to receive a threaded adjustable knob. To adjust the overall length of the shaft 112, the adjustable knob may be loosened so that the outer portion of the shaft moves relative to the inner portion of the shaft. Thus, once the user adjusts the overall length of the shaft to a suitable length, or the adjustable knob may be tightened to once again prevent the outer shaft portion from moving relative to the inner shaft portion. In an alternative embodiment, the shaft may also be made of two or more sections that can be screwed together or unscrewed to customize the length of the shaft. In still an alternative embodiment, the shaft may also have a push button type locking pin (e.g., a spring loaded pin or a spring loaded ball) (not shown) positioned in an outer circumference of the inner portion of the elongated shaft and a plurality of matching holes formed through the outer section of the elongated shaft thereby allowing the user to selectively fix the length of the shaft by affixing the locking pin in one of the holes.

In addition to the coupling, a handle is mounted on the shaft first portion 112a adjacent to the coupling 116. Referring in particular to FIG. 6, the shaft first portion 112a terminates in a generally conical end 120. In addition, a blind bore 122 is formed in the conical end 120 that is configured to receive a peg 124. The peg 124 assists in connecting the coupling 116 to the conical end 120 as well as centering the coupling on the conical end of the shaft.

The coupling 116 has a first end 116a configured to removeably retain the arcuate blade 114 to the coupling 116, and a second end 116b that is configured to fixedly retain the elongated shaft first end 120 to the coupling. In particular embodiments, the coupling second end 116b has a blind bore (not shown) formed therein that is configured to partially receive the conical end 120 of the shaft first portion 112a and the peg 124. In particular embodiments, the shaft first portion conical end 120 is press-fit into the coupling second end bore (not shown). In other embodiments, the shaft first portion conical end 120 is inserted into the coupling second end bore and retained therein by a fastener 126 (e.g., a rivet, a screw, a nut and bolt, a cotter pin, etc.). In still other embodiments, the coupling second end bore may be threaded on an inner diameter (not shown) and the shaft first portion conical end 120 may be threaded on an outer diameter (not shown). In these embodiments, the first portion conical end 120 is connected to the coupling 116 by a threaded engagement. In particular embodiments, the coupling 116 is generally cylindrical (e.g., cylindrical) in shape and the second end bore (not shown) is also cylindrical in shape. In other embodiments, the coupling 116 may be of any suitable shape (e.g., cylindrical, rectangular, elliptical, or square) that corresponds with the shape of the elongated shaft 112. Moreover, the coupling second end bore (not shown) may be of any suitable shape (e.g., a shape that corresponds to the elongated shaft) to facilitate a fixed or removable connection to the shaft.

The coupling first end 116a has a longitudinal slot 128 formed therein that terminates into a cylindrical through hole 130 that is formed perpendicular to a longitudinal axis of the coupling 116. The longitudinal slot 128 splits the coupling first end 116a into two halves 116c and 116d. Two threaded holes 132 and 134 are formed perpendicular to the longitudinal axis of the coupling 116 and are each configured to receive a respective threaded bolt 136 and 138 for maintaining the implement within the coupling. In other embodiments, a quick disconnect mechanism may be used to releasably retain the implement flat portion within the coupling slot. For example, in some embodiments, a spring loaded detent (e.g., a spring loaded ball, a spring loaded pin, or any other suitable quick disconnect mechanism) may be configured to operatively engage with a catch (e.g., a through hole, etc.) that is formed on or through the implement flat portion to releasably retain the implement within the coupling slot.

Exemplary Hiking Stick Operation

Still referring to FIG. 6, the implement (e.g., arcuate blade 114) is retained in the coupling 116 by a flat portion 114a formed at an end of the arcuate blade 114. The flat portion 114a also contains two through holes 140 and 142 that are configured to receive the threaded bolts 136 and 138, respectively.

In operation, the walking stick 110 allows the user to change out the implement (e.g., arcuate blade 114) that is received and retained in the coupling 116. In particular embodiments, the user may remove threaded bolts 136 and 138 and slide the arcuate blade 114 out from the longitudinal slot 128 defined between the first and second halves 116c and 116d of the coupling first end 116a. Referring to FIGS. 7A-7D, additional implements are illustrated for use with the walking stick 110. In particular, FIG. 7A illustrates a spear head 144 having a flat portion 144a and first and second through holes 146 and 148 for use with the coupling 116. FIG. 7B illustrates a fishing spear 150 having a flat portion 150a and first and second through holes 152 and 154 for use with the coupling 116. FIG. 7C illustrates a saw 156 having a flat portion 156a and first and second through holes 158 and 160 for use with the coupling 116. Finally, FIG. 7D FIG. 7B illustrates a sling shot 162 having a flat portion 162a and first and second through holes 164 and 166 for use with the coupling 116.

Referring once more to FIG. 6, when the user wishes to connect a different implement to the coupling the user removes the first and second threaded bolts 136 and 138 from the threaded openings 132 and 134, respectively and slides the implement flat portion (e.g., 114a) out from between the two halves 116c and 116d of the coupling first end 116a. In various embodiments, the two halves 116c and 116d may be slightly pulled apart from each other to provide clearance and allow the implement 114 to easily be removed. Each coupling half 116c and 116d is somewhat flexible about the area adjacent the cylindrical through hole 130. Once the implement is removed, the user may choose from anyone of the various implements shown in FIGS. 6 and 7A-7D. Once the user chooses the implement, the flat portion of the chosen implement (e.g., any one of flat portions 114a, 144a, 150a, 156a, and 162a) is slid into the longitudinal slot 128 and seated between the coupling two halves 116c and 116d. Once seated, the user inserts the two threaded bolts 136 and 128 into respective threaded through holes 132 and 134 until the coupling two halves 116c and 116d clamp down onto the implement flat portion. The user may then use the walking stick as an axe (e.g., arcuate blade 114), as a throwing spear (e.g., spear head 144), for fishing (e.g., fishing spear head 150), as a saw (e.g., saw head 156) or for hunting (e.g., sling shot 162).

In various embodiments, the coupling 116 may be formed from a first part and a second part that is pivotally coupled to the first part. In some embodiments, the pivotal coupling may comprise a locking mechanism that allows the coupling first portion and the coupling second portion to be locked in one of a extended position or a folded position. In some of these embodiments, the elongated shaft first portion may be configured to have a slot formed therein that allows a portion of the implement to be received in the slot when the coupling is in the folded position. This allows the implement to be at least partially stored when the implement is not in use.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations as confirmed by the various embodiments disclosed herein. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation. The description of the above exemplary embodiments should teach one of skill in the art that many more alternatives exist to include other wilderness tools in the design of a walking stick.

We claim:

1. A hiking stick comprising:
a. an elongated shaft having a first end and a second end;
b. a handle coupled to the elongated shaft second end;
wherein the handle comprises an arcuate blade having:
i. a spear tip;
ii. a socket configured to attach to the elongated shaft second end;
iii. a generally concave blade positioned intermediate the spear tip and the socket; and
iv. a generally convex blade positioned intermediate the spear tip and the socket.

2. The hiking stick of claim 1, wherein the socket has a first end and a second end that defines a blind bore formed therein;

3. The hiking stick of claim 2, wherein the arcuate blade is coupled to the socket first end by weldments.

4. The hiking stick of claim 2, wherein the arcuate blade is integrally formed with the socket.

5. The hiking stick of claim 2, wherein the socket second end blind bore is configured to fixedly retain the elongated shaft second end therein.

6. The hiking stick of claim 5, wherein the elongated shaft second end is received in the socket second end blind bore and retained therein by a press-fit.

7. The hiking stick of claim 5, wherein the elongated shaft second end is received in the socket second end blind bore and retained therein by a fastener.

8. The hiking stick of claim 7, wherein the fastener is selected from a group consisting of:
a. a rivet;
b. a screw;
c. a nut and bolt;
d. a cotter pin; and
e. a threaded engagement.

9. The hiking stick of claim 1, further comprising a first concave grind line that extends from the arcuate blade first end to the spear tip and that is separated from a concave blade edge of the concave blade by a concave blade surface that extends from the concave blade edge to the first concave grind line.

10. The hiking stick of claim 1, further comprising a second convex grind line that extends from the spear tip to approximately the blade first end and that is separated from a convex blade edge by a convex blade face that extends from the convex blade edge to the second convex grind line.

11. A blade for use with a hiking stick comprising:
a. a curved blade having a first end and a spear shaped second end;
b. an elongated socket connected to the blade first end where the socket is configured to attach to an elongated hiking stick;
c. a concave blade portion positioned intermediate the spear shaped second end and the blade second end, wherein the concave blade portions is configured to cut tree branches; and
d. a convex blade portion positioned intermediate the spear shaped second end and the blade second end;
wherein,
i. the point of the spear tip is substantially centered on a central axis of the elongated socket;
ii. a first portion of a cutting edge of the spear tip is formed from a portion of the convex blade that is distal from the socket,
iii. a second portion of a cutting edge of the spear tip is formed from two generally triangular blade faces that together form a second portion of the spear tip, and
iv. a distal end of the concave blade portion terminates at the two generally triangular blade faces.

12. The hiking stick of claim 11, wherein the socket has a first end that is integrally formed with the blade and a second end that defines a blind bore that is centered on the central axis.

13. The hiking stick of claim 12, wherein the blind bore is configured to fixedly retain an elongated shaft within the socket second end blind bore.

14. The hiking stick of claim 13, further comprising an elongated shaft having a first end and a second end that is received in the socket second end blind bore and that is retained therein by a press-fit.

15. The hiking stick of claim 13, further comprising an elongated shaft having a first end and a second end that is received in the socket second end blind bore and that is retained therein by a fastener.

16. The hiking stick of claim 11 further comprising a removable sheath that is configured to cover the curved blade.

17. The hiking stick of claim 16, wherein the removable sheath is configured to function as a handle for a user to grasp when using the hiking stick to traverse terrain.

18. A hiking stick comprising:
a. an elongated shaft having a first end and a second end;
b. a coupling having:
i. a longitudinal axis extending between a first end and an opposite second end of the coupling;
ii. a longitudinal slot bisecting the coupling first end such that the coupling first end is configured to releasably retain an implement therein; and
iii. a second end that is configured to fixedly attached to the elongated shaft first end; and
c. an implement having a flat portion that is configured to be releasably retained in the coupling longitudinal slot.

19. The hiking stick of claim 18, wherein the implement is chosen from a group comprising:
a. an arcuate blade;
b. a throwing spear head;
c. a fishing spear head having at least two prongs;
d. a saw head having at least one saw blade; and
e. a sling shot.

20. The hiking stick of claim 18, wherein
a. the coupling first end contains at least two through holes formed perpendicular to the coupling longitudinal axis;
b. the implement flat portion contains at least two through holes that are configured to align with the respective through holes formed through the coupling first end, and
c. at least two fasteners are releasably received through the respective coupling at least two through holes and the implement flat portion at least two through holes to releasably connect the implement to the coupling first end.

21. The hiking stick of claim 18, wherein
a. the coupling first end further comprises a quick disconnect mechanism; and
b. the implement flat portion is configured to releasably connect to the quick disconnect mechanism.

22. The hiking stick of claim 21, wherein
a. the quick disconnect mechanism further comprises a spring loaded detent; and
b. the implement flat portion further comprises a catch that is configured to operatively engage with the spring loaded detent.

23. The hiking stick of claim 22, wherein the spring loaded detent is a spring loaded pin.

24. The hiking stick of claim 18, further comprising a removable sheath that is configured to substantially cover the implement.

25. The hiking stick of claim 24, wherein the removable sheath is further configured to allow a user to grasp the implement.
